(19) United States
(12) Patent Application Publication
(10) Pub. No.: US 2012/0170477 A1
(43) Pub. Date: Jul. 5, 2012

(54) Computer, communication system, network connection switching method, and program

(75) Inventor: Satoshi HIEDA, Tokyo (JP)

(73) Assignee: NEC CORPORATION, Tokyo (JP)

(21) Appl. No.: 13/137,333

(22) Filed: Aug. 5, 2011

Related U.S. Application Data
(63) Continuation of application No. PCT/JP2011/050544, filed on Jan. 14, 2011.

(30) Foreign Application Priority Data
Jan. 14, 2010 (JP) 2010-005919

(51) Int. Cl. H04L 12/26

(52) U.S. Cl. 370/252

(57) ABSTRACT

A computer comprises: a virtual network interface device; a first virtual switch connected to a first physical network interface device; a second virtual switch connected to a second physical network interface device; a communication analysis unit (or path control unit) that, based on a result of communication with a packet transmission destination obtained by analyzing a packet transmitted from the virtual network interface device, selects to which of the first virtual switch and the second virtual switch the virtual network interface device is to be connected; and a connection setting unit that holds a connection between the virtual switch selected by the communication analysis unit (or path control unit) and the virtual network interface device.

### CROSS REFERENCES TO RELATED APPLICATIONS

This application is a continuation of International Patent Application No. PCT/JP2011/050544, filed on Jan. 14, 2011, and claims priority to Japanese Patent Application No. 2010-005919 filed on Jan. 14, 2010, both of which are incorporated herein by reference in their entireties.

The present invention relates to a computer, a communication system, a network connection switching method, and a program, and more particularly to a computer having multiple physical network interface devices, a communication system, a network connection switching method, and a program.

### BACKGROUND

Patent Document 1 and Patent Document 2 describe an example of a network connection system having multiple physical network interface devices. Patent Document 1 describes the configuration of a transmission device having network connection devices (for example, Network Interface Card (NIC)) for connection to a network, wherein the user sets a network connection device to be used for each application to allow the driver wrapper to assign an appropriate network connection device to each application program.

Patent Document 2 describes the configuration of a computer system capable of using multiple network interfaces, wherein an interface selection unit is provided for selecting a network interface that minimizes the response time.

Recently, the technology called OpenFlow is proposed (see Non-Patent Documents 1 and 2). OpenFlow identifies communications as end-to-end flows and performs path control, failure recovery, load balancing, and optimization on a per-flow basis. An OpenFlow switch, which functions as a transfer node, has a secure channel for communication with an OpenFlow controller and operates according to the flow table to which information is added, and whose contents are rewritten, according to an instruction from the OpenFlow controller as necessary. In the flow table, a set of the following three is defined for each flow: a rule (Header Fields) against which a packet header is matched, an action (Actions) that defines processing contents, and flow statistical information (Counters) (see FIG. 8).

The OpenFlow switch is implemented by installing the above-described function in a physical switch supplied by vendors. For example, when a packet is received, the OpenFlow switch searches the flow table for an entry that has a rule that matches the header information of the received packet. If an entry matching the received packet is found as a result of the search, the OpenFlow switch performs the processing contents (transfer the packet to the next hop, rewrite the packet, discard the packet), described in the Actions field of the entry, for the received packet. On the other hand, if an entry matching the received packet is not found as a result of the search, the OpenFlow switch transfers the received packet to the OpenFlow controller via the secure channel, requests the OpenFlow controller to determine a packet path based on the transmission source/destination of the received packet, receives a flow entry for performing this action, and updates the flow table.
[Patent Document 1] Japanese Patent Kokai Publication No. JP-P2005-072759A
[Patent Document 2] Japanese Patent Kokai Publication No. JP-P2009-219003A
[Non-Patent Document 1] Nick McKeown and seven other authors, “OpenFlow: Enabling Innovation in Campus Networks,” [online], [Searched on Dec. 14, 2009], Internet <URL: http://www.openflowswitch.org//documents/openflow-wp-latest.pdf>
[Non-Patent Document 2] “Openflow Switch Specification” Version 0.9.0. (Wire Protocol 0x98) [Searched on Dec. 14, 2009], Internet <URL: http://www.openflowswitch.org/documents/openflow-spec-v0.9.0.pdf>

### SUMMARY

The disclosed contents of Patent Documents 1 and 2 and Non-Patent Documents 1 and 2 given above are hereby incorporated by reference into this specification.

The following analysis is made by the present invention.

The method of Patent Document 1 described above requires the transmission device to prepare the path control information on multiple physical network interface devices (see FIG. 8 in Patent Document 1). That is, the problem is that, for each application, the user must identify and set the information in advance that indicates from which physical network interface device a packet is to be transmitted.

The method of Patent Document 2 is that a signal is transmitted from each of the network interfaces to the same communication destination and the network interface on which the response time is shortest is selected. The problem with this method is that the network interface via which a packet is received is sometimes different from the network interface via which the packet is transmitted. For example, a packet is received via a network interface not selected by the interface selection unit (selection engine) and the response to the packet is transmitted via another network interface selected by the interface selection unit (selection engine), in which case a failure occurs in a Transmission Control Protocol (TCP) session.

Therefore, there is a need in the art to provide a computer, a network connection switching method, and a program that can select a network interface, which does not generate a failure in a TCP session, from different network interfaces without requiring the user to set the path control information described above.

According to a first aspect of the present invention, there is provided a computer comprising: a virtual network interface device; a first virtual switch connected to a first physical network interface device; a second virtual switch connected to a second physical network interface device; a communication analysis unit that, based on a result of communication with a packet transmission destination obtained by analyzing a packet transmitted from the virtual network interface device, selects to which of the first virtual switch and the second virtual switch the virtual network interface device is to be connected; and a connection setting unit that holds a connection between the virtual switch selected by the communication analysis unit and the virtual network interface device.

According to a second aspect of the present invention, there is provided a network connection switching method comprising: based on a result of communication with a packet transmission destination obtained by analyzing a packet transmitted from the virtual network interface device included in a computer, selecting to which of a first virtual switch and a second virtual switch a virtual network interface device is to be connected; and maintaining the connection between the selected virtual switch and the virtual network interface device.

This method is related to a particular machine called a computer in which a virtual network interface device is built using the computer resources.

According to a third aspect of the present invention, there is provided a program causing a computer to execute: based on a result of communication with a packet transmission destination obtained by analyzing a packet transmitted from the virtual network interface device included in a computer, selecting to which of a first virtual switch and a second virtual switch a virtual network interface device is to be connected; and maintaining the connection between the selected virtual switch and the virtual network interface device.

This program may be recorded on a non-transient computer-readable storage medium. That is, the present invention may be implemented by a computer program product.

According to a fourth aspect of the present invention, there is provided communication system comprising a computer and a path control unit, wherein the computer comprises: a virtual network interface device; a first virtual switch connected to a first physical network interface device; a second virtual switch connected to a second physical network interface device; and a connection setting unit that receives from the path control unit an instruction indicating a virtual switch to be connected to the virtual network interface device and holds a connection between the virtual switch and the virtual network interface device, and the path control unit, receiving a packet from the virtual network interface device and using network topology information representing a connection mode of a plurality of communication devices managed by the path control unit, selects to which of the first virtual switch and the second virtual switch the virtual network interface device is to be connected.

The present invention provides the following advantage, but not restricted thereto. According to the present invention, the configuration is employed in which, for use in packet transmission, an appropriate virtual switch is selected from the multiple virtual switches, connected to different physical network interface devices, according to the transmission destination IP address of the packet to be transmitted without having to set path control information in the computer.

### BRIEF DESCRIPTION OF THE DRAWINGS

FIG. 1 is a block diagram showing a configuration of a first exemplary embodiment.

FIG. 2 is a diagram showing an example of the operation mode of the operating system (OS) in the present invention.

FIG. 3 is a diagram showing another example of the operation mode of the OS in the present invention.

FIG. 4 is a flowchart showing an operation of the first exemplary embodiment.

FIG. 5 is a diagram showing an operation of the first exemplary embodiment in a specific network configuration.

FIG. 6 is another diagram showing an operation of the first exemplary embodiment in a specific network configuration.

FIG. 7 is a block diagram showing a configuration of a second exemplary embodiment.

FIG. 8 is a diagram showing an example of a routing table stored in the computer in the second exemplary embodiment.

FIG. 9 is a diagram showing an example of network topology information referenced by the computer in the second exemplary embodiment.

FIG. 10 is a flowchart showing an operation of the second exemplary embodiment.

FIG. 11 is a diagram showing an operation of the second exemplary embodiment in a specific network configuration.

FIG. 12 is another diagram showing an operation of the second exemplary embodiment in a specific network configuration.

FIG. 13 is a block diagram showing a configuration of a third exemplary embodiment.

FIG. 14 is a flowchart showing an operation of the third exemplary embodiment.

### PREFERRED MODES

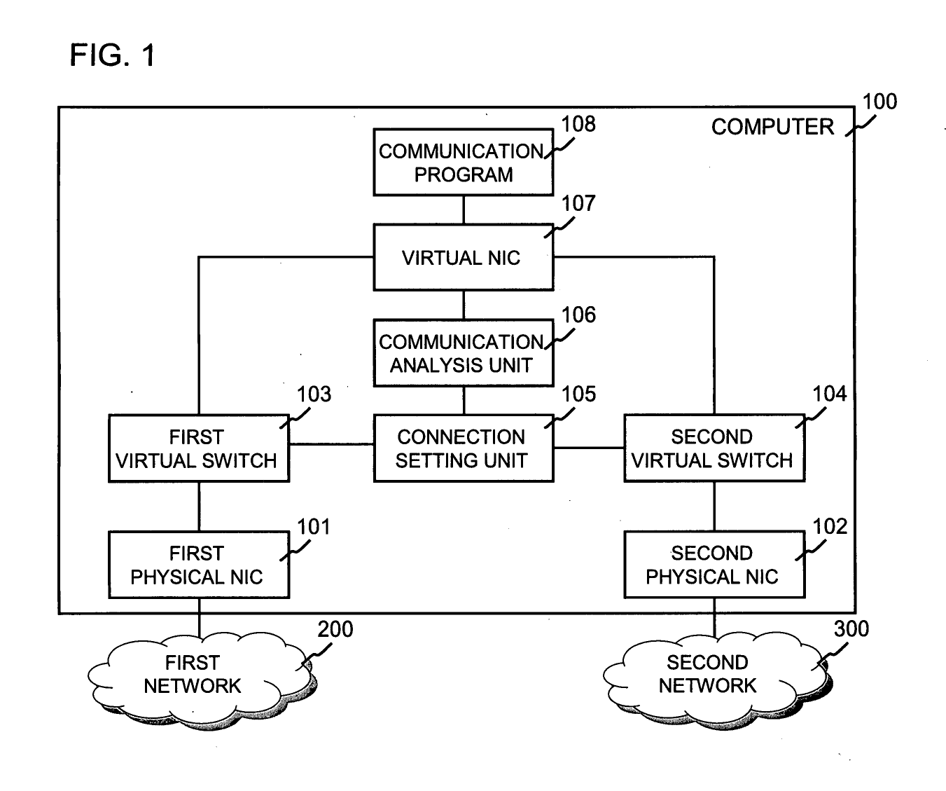

In the present disclosure, there are various possible modes, which include the following, but not restricted thereto. First, the following describes the overview of the present invention with reference to the drawings. As shown in FIG. 1, the present invention is applicable to a computer 100 that comprises multiple different network interfaces such as a first physical NIC 101 and a second physical NIC 102. The computer 100 of the present invention comprises a first virtual switch 103 connected to the first physical NIC 101; a second virtual switch 104 connected to the second physical NIC 102; a virtual NIC 107 identified by a communication program 108, which operates in the computer 100, as a network interface; a communication analysis unit 106 that analyzes a packet transmitted from the virtual NIC 107 and selects a virtual switch, first virtual switch 103 or second virtual switch 104, to which the virtual NIC 107 is to be connected; and a connection setting unit 105 that maintains the connection between the virtual switch 103/104, selected by the communication analysis unit 106, and the virtual NIC 107. The reference numerals are used in the description of the overview only to help understand the description but are not limited to the mode that is shown.

More specifically, the communication analysis unit 106 communicates with the computer (transmission destination computer) having the transmission destination IP address included in a transmission packet transmitted from the virtual NIC 107 and selects one of the first virtual switch 103 and the second virtual switch 104 using a predetermined selection rule by which a virtual switch that has a shorter response time, that has a higher throughput, or that has a fewer communication hops is selected. This achieves the object of selecting an appropriate network interface without using the path control information and without generating a TCP session failure.

The present invention is applicable also to the selection of the physical network interface in a computer connected to a path control unit (path control device) corresponding to the OpenFlow controller described in Non-Patent Documents 1 and 2. This configuration will be described later as second and third exemplary embodiments.

According to the present invention, the following modes are possible.

### [First Mode]

See the computer in the first aspect above.

### [Second Mode]

In the computer, the first physical network interface device may be connected to a first network; the second physical network interface device may be connected to a second network; and, the connection setting unit may disconnect the connection between the virtual network interface device and the virtual switch, when the connection between the first physical network interface device and the first network or the connection between the second physical network interface device and the second network is disconnected.

### [Third Mode]

In the computer, the communication analysis unit may not exist; the connection setting unit may receive from a path control unit an instruction indicating a virtual switch to be connected to the virtual network interface device; the connection setting unit may hold a connection between the virtual switch indicated by the path control unit and the virtual network interface device; and the path control unit, receiving a packet from the virtual network interface device and using network topology information representing a connection mode of a plurality communication devices managed by the path control unit, may select to which of the first virtual switch and the second virtual switch the virtual network interface device is to be connected.

### [Fourth Mode]

In the computer, the first and second physical network interface devices may be connected respectively to first and second physical switches controlled by the path control unit.

### [Fifth Mode]

In the computer, the path control unit, using the network topology information, as well as failure information or traffic information collected from at least one of the plurality of the communication devices, may select to which of the first virtual switch and the second virtual switch the virtual network interface device is to be connected.

### [Sixth Mode]

In the computer, the path control unit may set an entry in a routing table of each communication device on the first network or the second network to control a path of a packet transmitted and received between the virtual network interface device and a transmission destination computer.

### [Seventh Mode]

See the network connection switching method in the second aspect above.

### [Eighth Mode]

A network connection switching method may comprise: based on network topology information representing a connection mode of a plurality of managed communication devices, selecting from which virtual switch, a first virtual switch or a second virtual switch in a computer, a packet to be transmitted from a virtual network interface device included in the computer is to be transmitted; and connecting the selected virtual switch and the virtual network interface device.

### [Ninth Mode]

See the program in the third aspect above.

### [Tenth Mode]

A program may cause a computer to execute: based on network topology information representing a connection mode of a plurality of managed communication devices, selecting from which virtual switch, a first virtual switch or a second virtual switch in a computer, a packet to be transmitted from a virtual network interface device included in the computer is to be transmitted; and connecting the selected virtual switch and the virtual network interface device.

Note that the network connection switching method and the program in [seventh mode] to [tenth mode] given above may also be expanded to the contents of the second mode to the sixth mode as with the communication system in the first mode.

The program may be stored on a non-transient computer-readable storage medium.

### First Exemplary Embodiment

Next, a first exemplary embodiment will be described more in detail with reference to the drawings. FIG. 1 is a block diagram showing the configuration of the first exemplary embodiment. FIG. 1 shows a computer 100 that can connect to both a first network 200 and a second network 300.

The computer 100 comprises a first physical network interface card (NIC) 101, a second physical NIC 102, a first virtual switch 103, a second virtual switch 104, a connection setting unit 105, a communication analysis unit 106, a virtual NIC 107, and a communication program 108. Although one virtual NIC 107 and one communication program 108 are shown in the example in FIG. 1, multiple virtual NICs 107 and multiple communication programs 108 may be provided in the computer 100.

The first physical NIC 101 and the second physical NIC 102, each of which is a communication device used by the computer 100 for communication with other computers, have different IP addresses assigned. In the present exemplary embodiment, it is assumed that the first physical NIC 101 is connected to the first network 200 and the second physical NIC 102 is connected to the second network 300.

The first virtual switch 103 and the second virtual switch 104, each of which is a software-emulated virtual switch, have the function to switch the packet transfer destination. The first virtual switch 103 is connected to the first physical NIC 101 and the second virtual switch 104 is connected to the second physical NIC 102.

The virtual NIC 107 is a software-emulated virtual network interface device. The communication program 108 executed in the computer 100 identifies this virtual NIC 107 as an NIC.

The communication program 108 is a program that communicates with other computers via the virtual NIC 107.

The communication analysis unit 106 analyzes a packet, which is transmitted from the communication program 108 via the virtual NIC 107, and acquires the transmission destination IP address of the packet. Based on the acquired transmission destination IP address, the communication analysis unit 106 selects one of the virtual switches, first virtual switch 103 or second virtual switch 104, to which the virtual NIC 107 is to be connected. Which to select, first virtual switch 103 or second virtual switch 104, is determined according to one of the following: which response time is shorter when another packet is transmitted, which throughput is higher, or which has a fewer communication hops.

To measure the response time when the packet is transmitted, the echo message of the Internet control message protocol (ICMP) is transmitted from the first virtual switch 103 and the second virtual switch 104 to the IP address of the packet transmission destination. After that, one of the virtual switches is selected which receives the echo replay message and whose response time is shorter.

The connection setting unit 105 connects the virtual NIC 107 and the virtual switch 103/104 according to the virtual switch assignment determined by the communication analysis unit 106 and keeps the status.

The connection between the virtual NIC 107 and the virtual switch 103/104, which has been established by the connection setting unit 105, may be released when the connection between the first physical NIC 101 and the first network 200 is disconnected or when the connection between the second physical NIC 102 and the second network 300 is disconnected. The reason is that, when the first physical NIC 101 and the second physical NIC 102 are reconnected to the network 200/300, there is a possibility that the network topology viewed from the virtual NIC 107 will be changed. For example, one possible case is that the user will mistakenly insert the communication cables into the NICs with the result that the first physical NIC 101 is connected to the second network 300 and the second physical NIC 102 is connected to the first network 200. In this case, it is desirable that the connection between the virtual NIC 107 and the virtual switch 103/104 be reset.

The first network 200 and the second network 300 are each a telecommunication network comprising multiple communication devices.

Next, the following describes the operation mode of the operating system (OS) in the present exemplary embodiment. In the present exemplary embodiment, the OS operates in one of the following two modes.

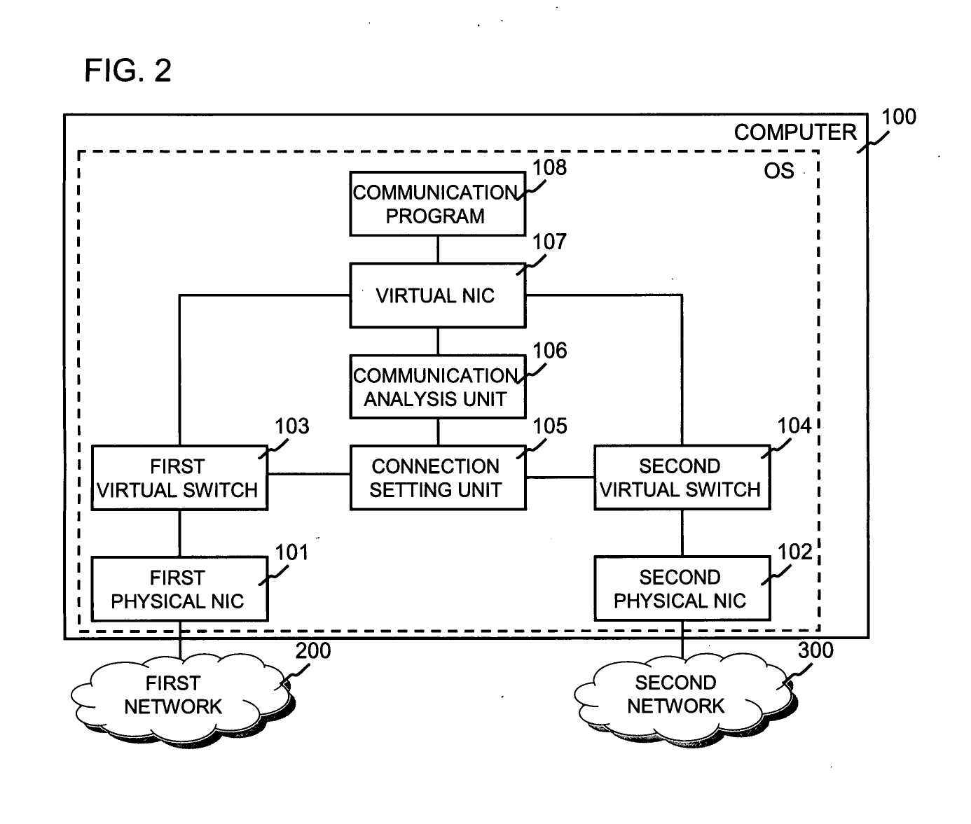

In the first operation mode, one OS operates in the computer 100 (see the broken line in FIG. 2). In this case, the components of the computer 100 are managed by one OS as shown in FIG. 2. When there are multiple virtual NICs 107 and communication programs 108, the multiple virtual NICs 107 and communication programs 108 also operate on the OS to perform the operation similar to that described above.

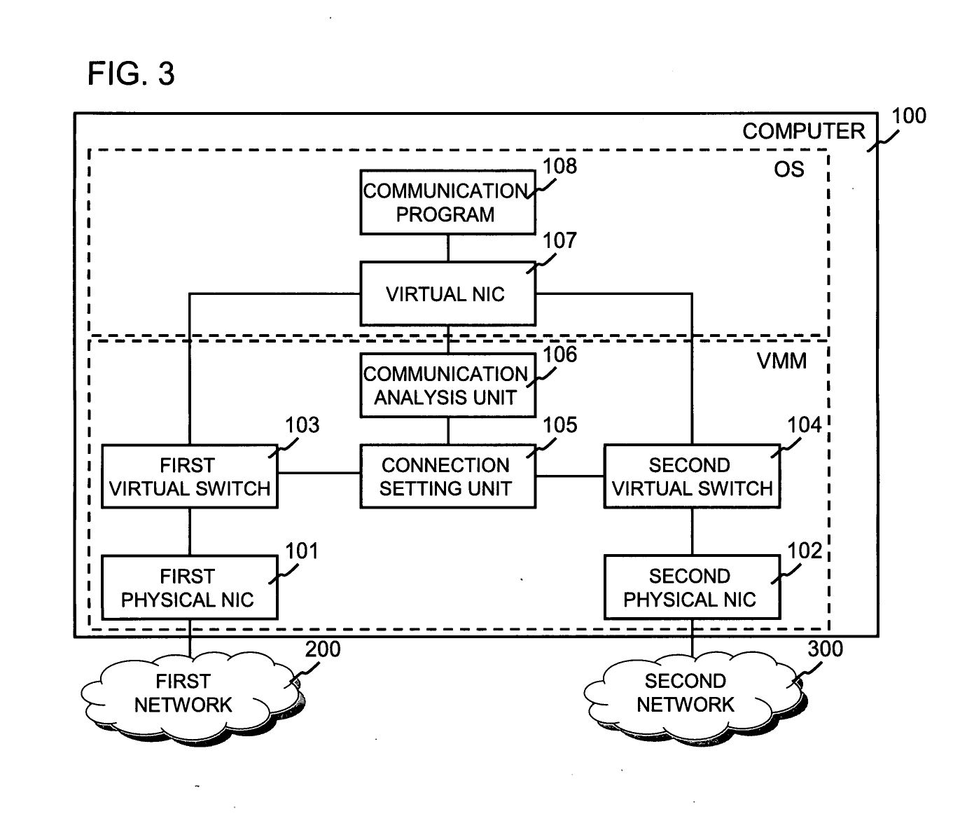

In the second operation mode, the virtualization technique, such as virtual machines (VM), is used to allow one or more OSs to operate in the computer 100 (see the broken line in FIG. 3). In this case, the virtual NIC 107 and the communication program 108 are managed by the OS that runs on the virtual machine monitor (VMM) as shown in FIG. 3 while the other components are managed by the VMM. When multiple OSs run on the VMM, the multiple virtual NICs 107 and communication programs 108 also perform the operation similar to that described above.

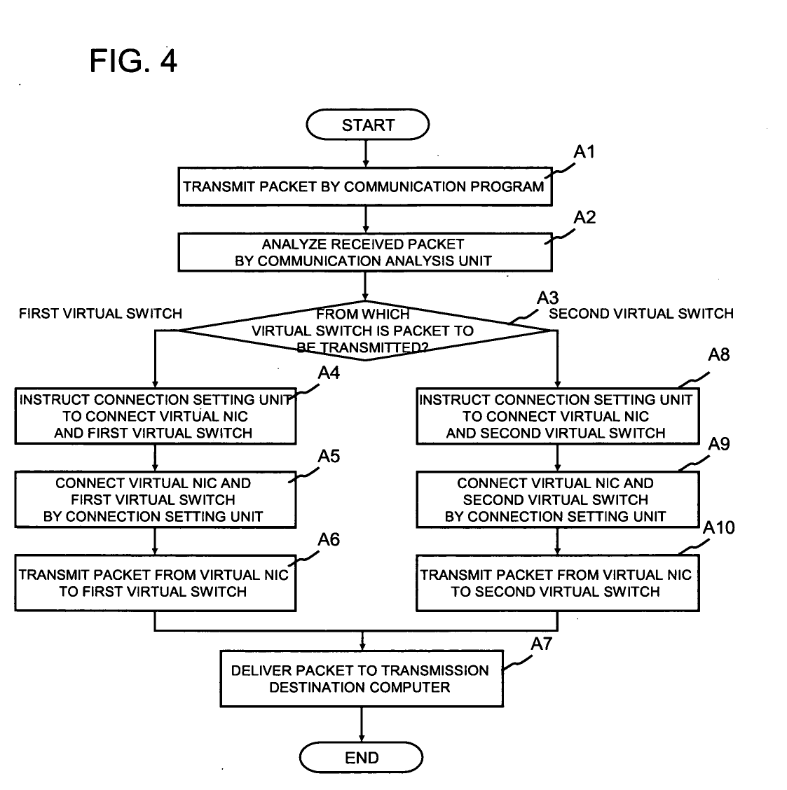

Next, the following describes the operation of this exemplary embodiment in detail below with reference to the drawings. FIG. 4 is a flowchart showing the operation of the first exemplary embodiment.

First, when the communication program 108 transmits a packet to communicate with another computer (hereinafter called a transmission destination computer) (step A1), the communication analysis unit 106 analyzes the received packet and acquires the transmission destination IP address of the packet (step A2).

After that, the communication analysis unit 106 selects one of the virtual switches, first virtual switch 103 or second virtual switch 104, from which the packet is to be transmitted to the transmission destination IP address (step A3).

If the first virtual switch 103 is selected for connection with the virtual NIC 107, the communication analysis unit 106 instructs the connection setting unit 105 to establish the connection between the virtual NIC 107 and the first virtual switch 103 (step A4). In response to the instruction from the communication analysis unit 106, the connection setting unit 105 connects the virtual NIC 107 and the first virtual switch 103 (step A5). In this case, the virtual NIC 107 transmits the packet to the first virtual switch 103 (step A6).

After that, the first virtual switch 103 transfers the packet to the first physical NIC 101 and then the packet is transferred from the first physical NIC 101 to the first network 200. The packet transmitted to the first network 200 is delivered to the final transmission destination computer via zero or more communication devices (step A7).

On the other hand, if the communication analysis unit 106 selects the second virtual switch 104 for connection with the virtual NIC 107 in step A3 above, the communication analysis unit 106 instructs the connection setting unit 105 to establish the connection between the virtual NIC 107 and the second virtual switch 104 (step A8). In response to the instruction from the communication analysis unit 106, the connection setting unit 105 connects the virtual NIC 107 and the second virtual switch 104 (step A9). In this case, the virtual NIC 107 transmits the packet to the second virtual switch 104 (step A10).

In this case, the second virtual switch 104 transfers the packet to the second physical NIC 102 and then the packet is transferred from the second physical NIC 102 to the second network 300. The packet transmitted to the second network 300 is delivered to the final transmission destination computer via zero or more communication devices (step A7).

The following describes the operation of the communication analysis unit 106 and the connection setting unit 105 more in detail using a specific example.

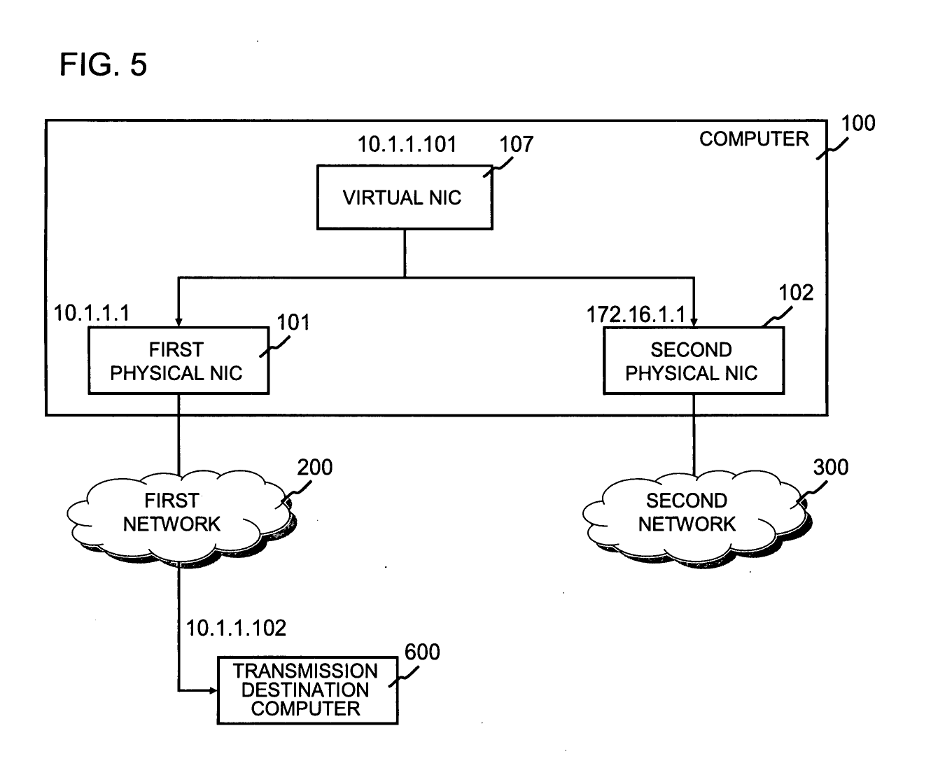

For example, in the network configuration such as the one shown in FIG. 5, consider the case in which the communication program 108 transmits a packet to a transmission destination computer 600, whose IP address is 10.1.1.102, via the virtual NIC 107. In this case, the communication analysis unit 106 transmits the ICMP echo message from the first virtual switch 103 and the second virtual switch 104 to measure the response time. In the network configuration shown in FIG. 5, no response is returned via the second virtual switch 104 and so it is determined that that the echo reply message is received sooner via the first virtual switch 103. To transmit the received packet from the first physical NIC 101, the communication analysis unit 106 instructs the connection setting unit 105 to connect the virtual NIC 107 and the first virtual switch 103.

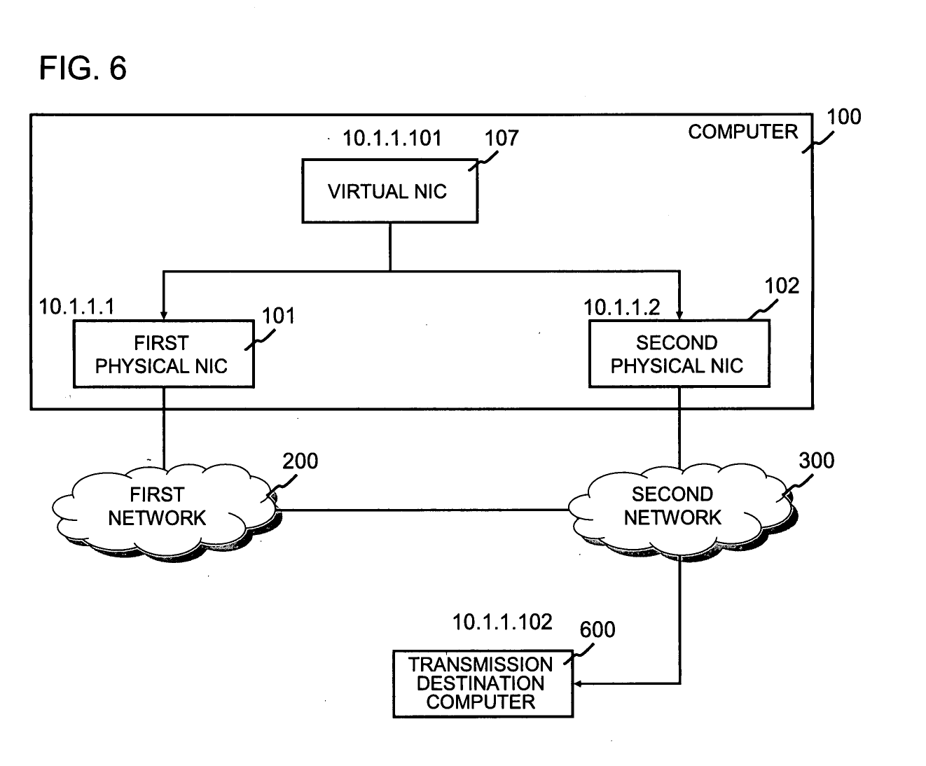

For example, in the network configuration such as the one shown in FIG. 6, consider the case in which the communication program 108 transmits a packet to the transmission destination computer 600, whose IP address is 10.1.1.102, via the virtual NIC 107. In this case, too, the communication analysis unit 106 transmits the ICMP echo message from the first virtual switch 103 and the second virtual switch 104 to measure the response time. As a result, assume that it takes 200 ms (milliseconds) for the ICMP reply message to be received via the first virtual switch 103, and 150 ms via the second virtual switch 104. In this case, to transmit the received packet from the second physical NIC 102, the communication analysis unit 106 instructs the connection setting unit 105 to connect the virtual NIC 107 and the second virtual switch 104.

In the present exemplary embodiment, the communication program 108, which is executed in the computer 100, can carry out communication appropriately considering the network topology as described above without requiring the user to set the path control information on the computer 100. The reason is that the communication analysis unit 106 is configured to select a virtual switch, to which the virtual NIC 107 is to be connected, when a communication request from the virtual NIC 107 is generated.

In addition, the connection setting unit 105 may be configured to release (disconnect) the connection between the virtual NIC 107 and the virtual switch when the connection between the first physical NIC 101 and the first network 200 or the connection between the second physical NIC 102 and the second network 300 is disconnected. This configuration reduces the need for the user to always keep track of which of the multiple physical NICs of the computer 100 is to be connected to which network. For example, assume that the user has mistakenly inserted communication cables into NICs with the result that the first physical NIC 101 is connected to the second network 300 and the second physical NIC 102 is connected to the first network. In such a case, by correctly reinserting the communication cables into the NICs or by switching the connection between the virtual NIC 107 and the virtual switches 103/104, the connection between the virtual NIC 107 and the virtual switch 103/104 can be reset correctly.

### Second Exemplary Embodiment

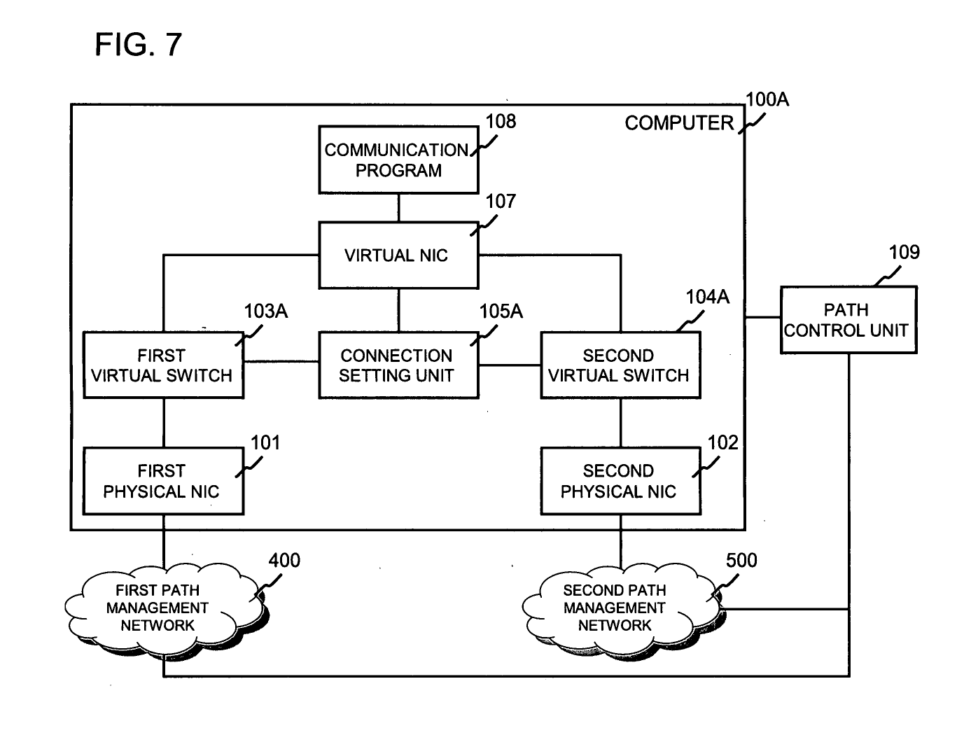

Next, a second exemplary embodiment will be described in detail with reference to the drawings. FIG. 7 is a block diagram showing the configuration of the second exemplary embodiment. FIG. 7 shows a computer 100A that can connect to both a first path management network 400 and a second path management network 500.

The computer 100A comprises a first physical NIC 101, a second physical NIC 102, a first virtual switch 103A, a second virtual switch 104A, a connection setting unit 105A, a virtual NIC 107, and a communication program 108. In addition, the computer 100A is connected to a path control unit 109. The first physical NIC 101, second physical NIC 102, virtual NIC 107, and communication program 108, to each of which the same reference numeral as that of the first exemplary embodiment is given, perform the same operation as that in the first exemplary embodiment and so the description is omitted here. The following mainly describes the difference from the first exemplary embodiment.

In the present exemplary embodiment, the virtual NIC 107 and the first virtual switch 103A are already connected. Therefore, a packet that is transmitted by the communication program 108 via the virtual NIC 107 is transmitted first to the first virtual switch 103A.

The first virtual switch 103A and the second virtual switch 104A in the present exemplary embodiment are software-emulated communication devices that perform the operation corresponding to that of the OpenFlow switch described in Non-Patent Documents 1 and 2. That is, the first virtual switch 103A and the second virtual switch 104A each have the function to transfer a packet according to the internally provided routing table. If the transfer destination is not determined by the routing table, the first virtual switch 103A and the second virtual switch 104A transfer the packet to the path control unit 109 to request it to set a new entry, which is to be applied to the packet, in the routing table.

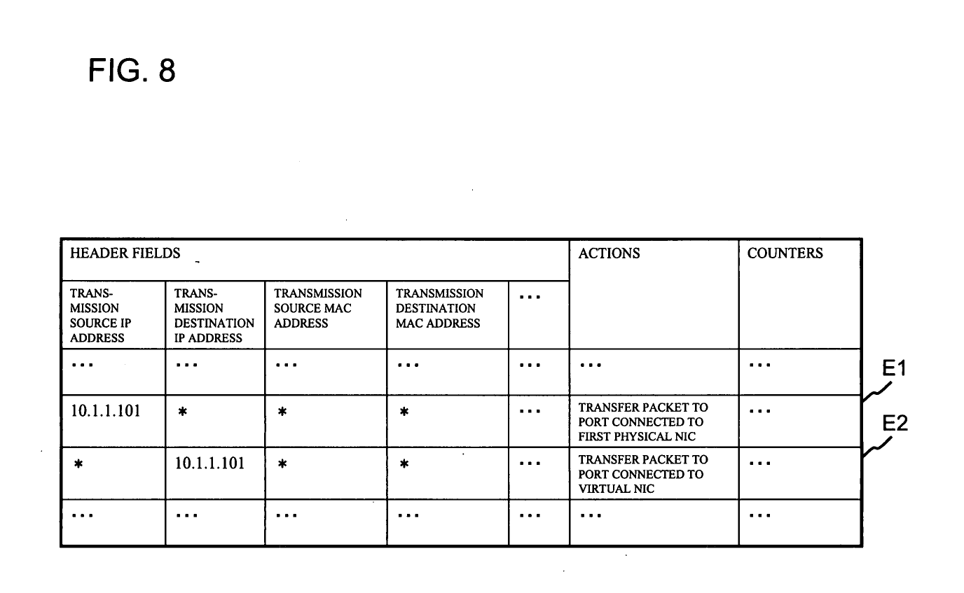

FIG. 8 is a diagram showing an example of the routing table corresponding to the flow table described in Non-Patent Documents 1 and 2. Each entry is composed of Header Fields, Counters, and Actions. The Header Fields is divided further into the following fields: Transmission Source IP Address, Transmission Source MAC (Media Access Control) Address, Transmission Destination IP Address, Transmission Destination MAC Address, Transmission Control Protocol (TCP) Port Number, and Virtual Local Area Network (VLAN) ID. The Counters field saves the number of times a received packet matches the entry. The Actions field specifies how to process a packet when the header field of the packet matches the contents of the Header Fields field of the routing table. For example, the Actions field stores an action to transfer a packet from the specified port number.

For example, consider the case in which the first virtual switch 103A has the routing table such as the one shown in FIG. 8. Assume that the first virtual switch 103A receives a packet, addressed to the transmission destination computer 600, from the virtual NIC 107 and that the transmission source IP address of the packet is 10.1.1.101 and, the transmission destination IP address is 10.1.1.102 (“*” denotes a wildcard). Upon receiving this packet, the first virtual switch 103A searches the routing table from the top of the table and gets a hit on entry E1 in which “10.1.1.101” is set as the transmission source IP address. In this case, the first virtual switch 103A transfers the packet to the port, to which the first physical NIC 101 is connected, according to the contents of the Actions field. On the other hand, when the first virtual switch 103A receives a packet from the transmission destination computer 600 as the response to the transferred packet and when the transmission source IP address of the packet is 10.1.1.102 and the transmission destination IP address 10.1.1.101, entry E2 is hit in which “10.1.1.101” is set as the transmission destination IP address. In this case, the first virtual switch 103A transfers the packet to the port, to which the virtual NIC 107 is connected, according to the contents of the Actions field. In this way, a sequence of packets (flow) is relayed between the node (virtual NIC 107) whose IP address is 10.1.1.101 and the transmission destination computer 600 whose IP address is 10.1.1.102.

When a packet is received from the first virtual switch 103A or the second virtual switch 104A, the path control unit 109 selects one of the virtual switches to which the virtual NIC 107 is to be connected, based on the network topology information stored in the path control unit 109.

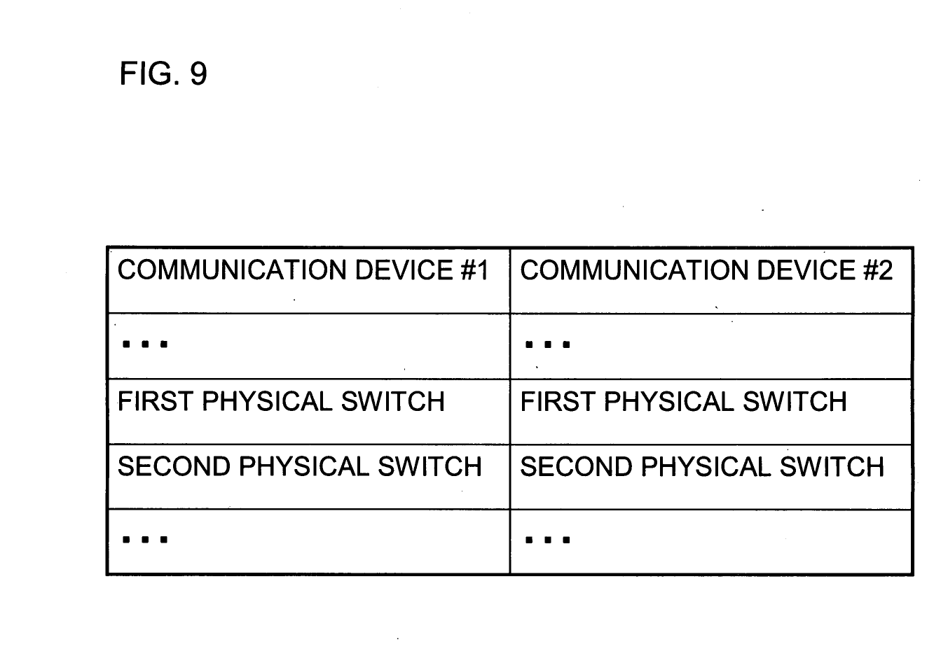

The network topology information is connection information on the communication devices managed by the path control unit 109 (including the communication devices connected to the first and second path management networks 400/500). The network topology information may have one of several formats. For example, the two connected communication devices are managed as a set as shown in FIG. 9.

By managing the connected communication devices as a set for all the communication devices managed by the path control unit 109 as shown in FIG. 9, a path from one communication device to another communication device may be determined.

For example, if the transmission destination IP address of a packet transferred from the first virtual switch 103A (or second virtual switch 104A) can be reached from the first virtual switch 103A, the path control unit 109 determines that the virtual NIC 107 should be left connected to the first virtual switch 103A.

On the other hand, if the transmission destination IP address of a packet transferred from the first virtual switch 103A (or second virtual switch 104A) can be reached from the second virtual switch 104A, the path control unit 109 determines that the virtual NIC 107 should be connected to the second virtual switch 104A.

If the transmission destination IP address of a packet transferred from the first virtual switch 103A (or second virtual switch 104A) can be reached from both the first virtual switch 103A and the second virtual switch 104A and if the communication from the first virtual switch 103A to the destination IP address requires a fewer hops, the path control unit 109 determines that the virtual NIC 107 should be connected to the first virtual switch 103A; conversely, if the communication from the second virtual switch 104A to the destination IP address requires a fewer hops, the path control unit 109 determines that the virtual NIC 107 should be connected to the second virtual switch 104A.

When it is determined that the virtual NIC 107 should be connected to the first virtual switch 103A as described above, the path control unit 109 sets an appropriate entry in the routing table for the first virtual switch 103A. When it is determined that the virtual NIC 107 should be connected to the second virtual switch 104A, the path control unit 109 sets an appropriate entry in the routing table for the second virtual switch 104A and, in addition, instructs the connection setting unit 105A to release the connection between the virtual NIC 107 and the first virtual switch 103A and to establish the connection between the virtual NIC 107 and the second virtual switch 104A.

Some packets transmitted from the virtual NIC 107 may be left in the first virtual switch 103A when the connection is switched as described above. Those packets may be transferred to the second virtual switch 104A at a time. Alternatively, those remaining packets may be deleted.

The path control unit 109 not only sets an appropriate entry in the routing table for the first virtual switch 103A and the second virtual switch 104A but also sets an entry in the routing table for the other communication devices in the first path management network 400 and the second path management network 500. This path control unit 109 may also be implemented by a control device corresponding to the OpenFlow controller, described in Non-Patent Documents 1 and 2, for controlling the path via which a packet is transmitted from one communication device (node) to the transmission destination computer.

The path control unit 109 may regularly collect the network topology information described above or the traffic information stored in the Counters field in the routing table shown in FIG. 8. The information collected in this way may be used to determine a new path and to cause each communication device to set an entry in the routing table when a failure or congestion is caused in a communication device in the network or when the network topology is changed.

The path control unit 109 may be provided in the computer 100A. In this case, the computer 100A is implemented by a device corresponding to the OpenFlow controller described in Non-Patent Documents 1 and 2.

The connection setting unit 105A connects the virtual NIC 107 and the first/second virtual switch 103A/104A according to the instruction from the path control unit 109. After the first physical NIC 101 is disconnected from the first path management network 400 and/or the second physical NIC 102 is disconnected from the second path management network 500, the network topology viewed from the virtual NIC 107 will be changed. Therefore, when the connection is disconnected in this way, the connection setting unit 105A may release the connection between the virtual NIC 107 and the first/second virtual switch 103A/104A. By doing so, the virtual NIC 107 can be reconnected to the first/second virtual switch 103A/104A according to the new network topology when a packet is received after the reconnection.

The first path management network 400 and the second path management network 500 are a telecommunication network comprising multiple communication devices. Like the first virtual switch 103A and the second virtual switch 104A, a communication device belonging to the first path management network 400 or the second path management network 500 comprises a routing table. When a new packet not matching any entry is received, the communication device transfers the packet to the path control unit 109, which sets an entry that defines an action to be applied to the packet. Therefore, a communication device belonging to the first path management network 400 or the second path management network 500 is implemented by a device corresponding to the OpenFlow switch described in Non-Patent Documents 1 and 2.

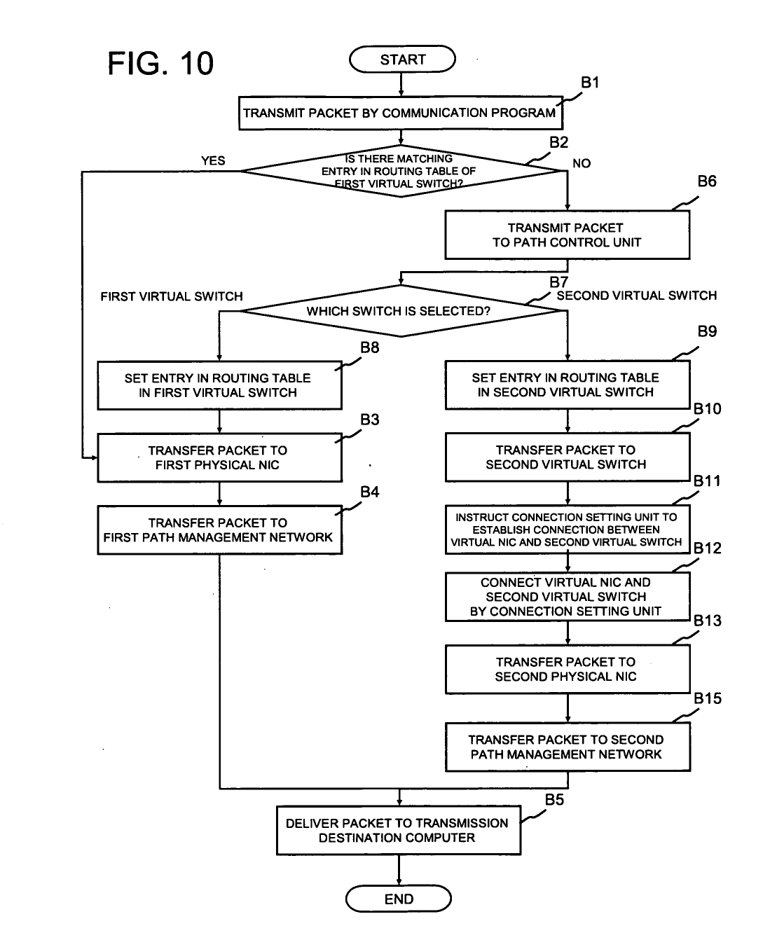

Next, the following describes an operation of the present exemplary embodiment in detail with reference to the drawings. FIG. 10 is a flowchart showing the operation of the second exemplary embodiment.

First, when the communication program 108 transmits a packet to communicate with the transmission destination computer 600 (step B1), the first virtual switch 103A references the routing table to search for an entry corresponding to the received packet transmitted via the virtual NIC 107 (step B2).

If an entry matching the received packet is found in the routing table in the first virtual switch 103A (Yes in step B2), the first virtual switch 103A transfers the received packet to the first physical NIC 101 according to the contents of the Actions field of the entry (step B3).

The first physical NIC 101, which has received the transferred received packet, transfers the received packet to the first path management network 400 (step B4). The received packet is delivered eventually to the transmission destination computer 600 via communication devices in the first path management network 400 (step B5).

On the other hand, if an entry matching the received packet is not found in step B2 (No in step B2), the first virtual switch 103A transmits the received packet to the path control unit 109 (step B6).

When the packet is received from the first virtual switch 103A, the path control unit 109 selects one of the virtual switches, to which the virtual NIC 107 is to be connected, based on the network topology information stored in the path control unit 109 (step B7).

If the first virtual switch 103A is selected as the virtual switch to which the virtual NIC 107 is to be connected, there is no need to switch the connection between the virtual NIC 107 and the first virtual switch 103A and the path control unit 109 sets an appropriate entry in the routing table in the first virtual switch 103A (step B8). This entry causes the received packet to be transmitted to the transmission destination computer 600 according to the operation in step B3 and the subsequent steps.

On the other hand, if the second virtual switch 104A is selected in step B7 as the virtual switch to which the virtual NIC 107 is to be connected, the path control unit 109 sets an appropriate entry in the routing table in the second virtual switch 104A (step B9) and transfers the packet to the second virtual switch 104A (step B10). In addition, the path control unit 109 instructs the connection setting unit 105 to switch the connection between the virtual NIC 107 and the first virtual switch 103A to the connection between the virtual NIC 107 and the second virtual switch 104A (step B11). In this case, the path control unit 109 may further instruct that the packets, which are transmitted from the virtual NIC 107 and are left in the first virtual switch 103A, be transferred to the second virtual switch 104A.

Next, the connection setting unit 105A disconnects the connection between the virtual NIC 107 and the first virtual switch 103A and connects the virtual NIC 107 and the second virtual switch 104A (step B12).

Then, the second virtual switch 104A transfers the packet to the second physical NIC 102 according to the entry that is newly set (step B13). After that, the second physical NIC 102 transfers the packet to the second path management network 500 (step B14) and the packet is delivered eventually to the transmission destination computer 600 via communication devices in the second path management network 500.

Referring to a specific example, the following describes the operation of the computer 100A and the path control unit 109 in this exemplary embodiment when a communication device on the first path management network 400 or the second path management network 500 fails.

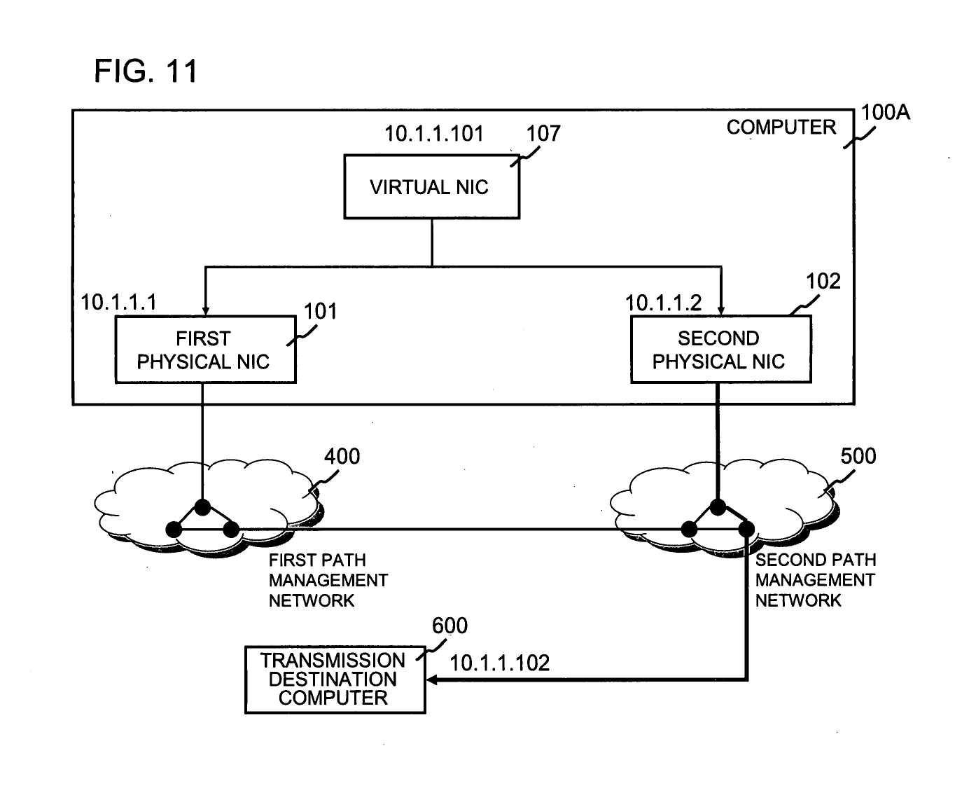

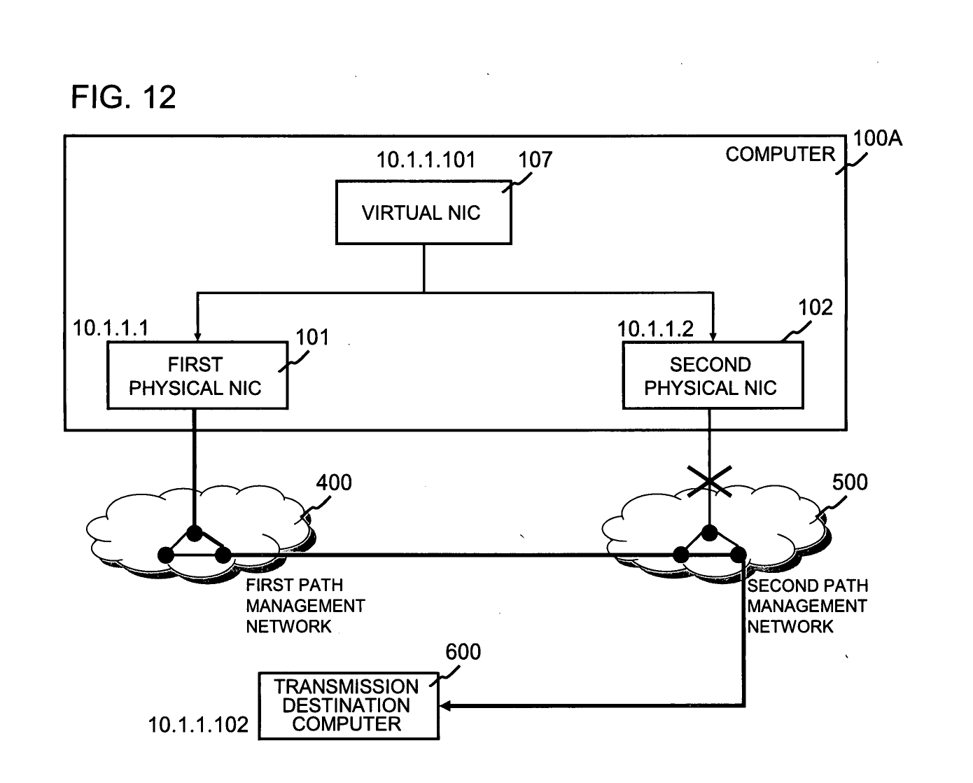

For example, assume that a path is already set from the virtual NIC 107 to the transmission destination computer 600 via the second path management network 500 in the network configuration shown in FIG. 11. When a failure occurs in the second path management network 500 as shown in FIG. 12, the path control unit 109 detects the failure and sets a new entry in the routing tables of the communication devices. In addition, the path control unit 109 instructs the connection setting unit 105A to switch the connection between the virtual NIC 107 and the second virtual switch 104A to the connection between the virtual NIC 107 and the first virtual switch 103A. This connection switching sets a new path from the virtual NIC 107 to the transmission destination computer 600 as shown in FIG. 12.

As described above, the path control unit 109 in the second exemplary embodiment is configured to select the virtual switch, to which the virtual NIC 107 is to be connected, based on the network topology information of the entire network and to set the path to the transmission destination computer 600. This configuration enables the communication program 108, which is executed on the computer 100A, to carry out appropriate communication considering the network topology without requiring the user to set the path control information on the computer 100A.

In addition, the connection setting unit 105A in the present exemplary embodiment may be configured to disconnect the connection between the virtual NIC 107 and the virtual switch when the connection between the first physical NIC 101 and the first path management network 400 or the connection between the second physical NIC 102 and the second path management network 500 is disconnected. This configuration eliminates the need for the user to keep track of which of the multiple physical NICs of the computer 100A is to be connected to which path management network.

### Third Exemplary Embodiment

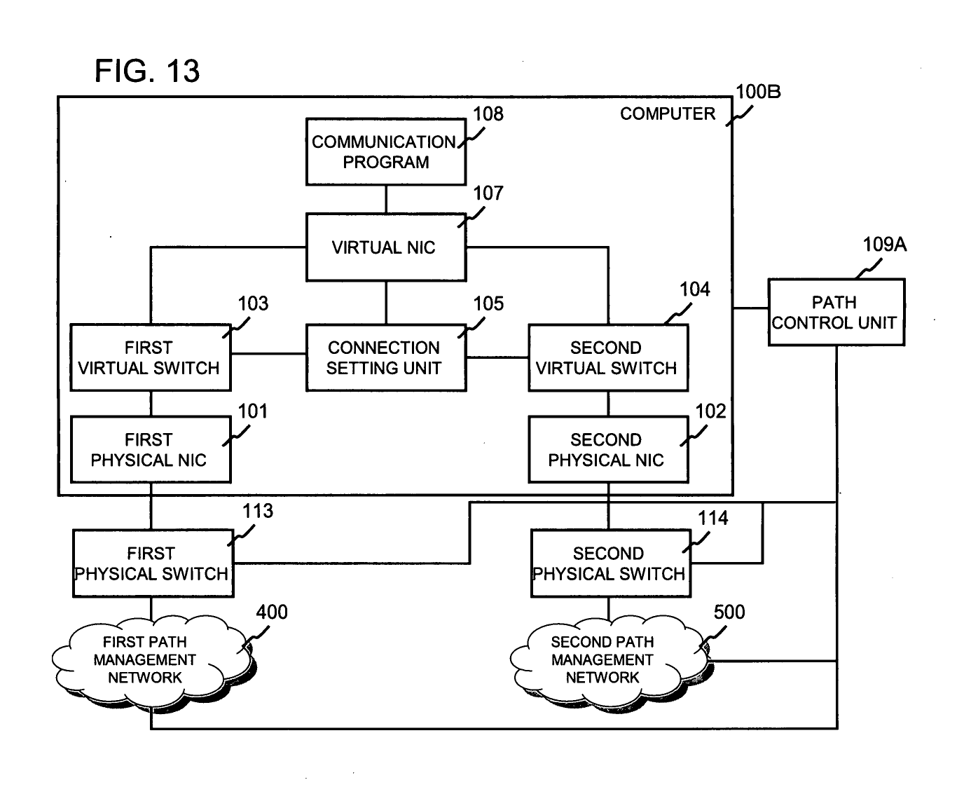

Next, a third exemplary embodiment will be described in detail with reference to the drawings. FIG. 13 is a block diagram showing the configuration of the third exemplary embodiment. FIG. 13 shows a computer 100B that can connect to both a first path management network 400 and a second path management network 500 via a first physical switch 113 and a second physical switch 114.

The computer 100B comprises a first physical NIC 101, a second physical NIC 102, a first virtual switch 103, a second virtual switch 104, a connection setting unit 105, a virtual NIC 107, and a communication program 108. In addition, the computer 100B is connected to a path control unit 109A. The first physical NIC 101, second physical NIC 102, first virtual switch 103, second virtual switch 104, connection setting unit 105, virtual NIC 107, and communication program 108, to each of which the same reference numeral as that of the first exemplary embodiment is given, perform the same operation as that in the first exemplary embodiment and so the description is omitted here. The following mainly describes the difference from the first exemplary embodiment.

The first physical switch 113 and the second physical switch 114 in the present exemplary embodiment are communication devices that have the function to transfer a packet according to the routing table in the switch. That is, the first physical switch 113 and the second physical switch 114 are communication devices that have the packet transfer function similar to that of the first virtual switch 103A and the second virtual switch 104A in the second exemplary embodiment.

When a packet is received from the first physical switch 113 or the second physical switch 114, the path control unit 109A in the present exemplary embodiment selects one of the virtual switches, first virtual switch 103 or second virtual switch 104, to which the virtual NIC 107 is to be connected, based on the network topology information stored in the path control unit 109A.

When the connection between the virtual NIC 107 and the first virtual switch 103 is selected, the path control unit 109A sets an appropriate entry in the routing table for the first physical switch 113. Similarly, when the connection between the virtual NIC 107 and the second virtual switch 104 is selected, the path control unit 109A sets an appropriate entry in the routing table for the second physical switch 114 and, in addition, instructs the connection setting unit 105 to switch the connection between the virtual NIC 107 and the first virtual switch 103 to the connection between the virtual NIC 107 and the second virtual switch 104. When the connection is switched, the path control unit 109A may also instruct the first physical switch 113 to transfer the received packets to the second physical switch 114. The path control unit 109A may also instruct the first physical switch 113 to delete the packets.

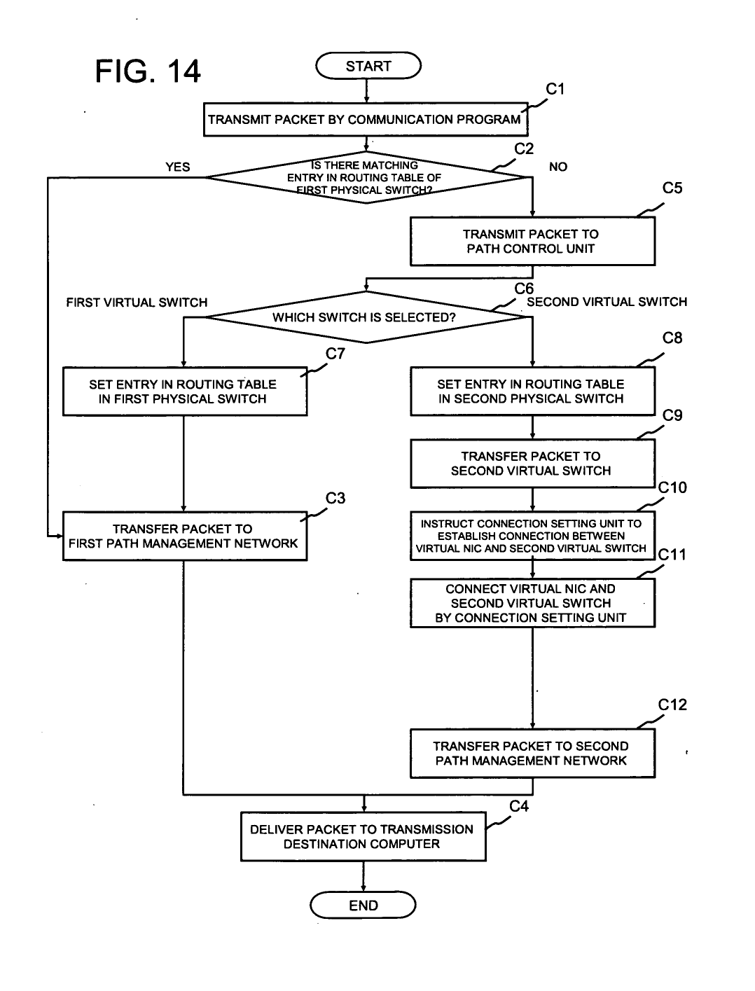

Next, the following describes an operation of the present exemplary embodiment in detail with reference to the drawings. FIG. 14 is a flowchart showing the operation of the third exemplary embodiment.

First, when the communication program 108 transmits a packet to communicate with the transmission destination computer 600 (step C1), the packet is transmitted from the virtual NIC 107 to the first physical switch 113 via the first virtual switch 103 and the first physical NIC 101.

When the packet is received, the first physical switch 113 searches the routing table for an entry (step C2).

If the routing table in the first physical switch 113 contains an entry that matches the packet (“Yes” in step C2), the packet is transferred to the communication device in the first path management network 400 specified by the entry (step C3). The packet is delivered eventually to the transmission destination computer 600 via communication devices in the first path management network 400 (step C4).

On the other hand, if an entry matching the received packet is not found in step C2 (No in step C2), the first physical switch 113 transmits the received packet to the path control unit 109A (step C5).

When the packet is received from the first physical switch 113, the path control unit 109A selects one of the virtual switches, to which the virtual NIC 107 is to be connected, based on the network topology information stored in the path control unit 109A (step C6).

If the first virtual switch 103 is selected as the virtual switch to which the virtual NIC 107 is to be connected, there is no need to switch the connection between the virtual NIC 107 and the first virtual switch 103 and the path control unit 109A sets an appropriate entry in the routing table in the first physical switch 113 (step C7). This entry causes the received packet to be transmitted to the transmission destination computer 600 according to the operation in step C3 and the subsequent steps described above.

On the other hand, if the second virtual switch 104 is selected in step C6 as the virtual switch to which the virtual NIC 107 is to be connected, the path control unit 109A sets an appropriate entry in the routing table in the second physical switch 114 (step C8) and transfers the packet to the second virtual switch 104 (step C9). In addition, the path control unit 109A instructs the connection setting unit 105 to switch the connection between the virtual NIC 107 and the first virtual switch 103 to the connection between the virtual NIC 107 and the second virtual switch 104 (step C10). In this case, the path control unit 109A may further instruct that the packets, which are transmitted from the virtual NIC 107 and are left in the first virtual switch 103, be transferred to the second virtual switch 104.

Next, the connection setting unit 105 disconnects the connection between the virtual NIC 107 and the first virtual switch 103 and connects the virtual NIC 107 and the second virtual switch 104 (step C11).

Then, the second physical switch 114 transfers the received packet to a communication device in the second path management network 500 according to the entry that is newly set (step C12). After that, the packet is delivered eventually to the transmission destination computer 600 via communication devices in the second path management network 500 (step C4).

As described above, even if the virtual switch is not managed by the path control unit 109A, the network connection switching equivalent to that of the second exemplary embodiment may be performed in the third exemplary embodiment. The reason is that the path control unit 109A is configured to select a virtual switch, to which the virtual NIC 107 is to be connected, based on the packet information received from the physical switches 113/114 to allow the communication program 108 executed on the computer 100B to carry out communication appropriately considering the network topology.

In addition, the connection setting unit 105 in the present exemplary embodiment may be configured to disconnect the connection between the virtual NIC 107 and the virtual switch when the connection between the first physical NIC 101 and the first path management network 400 or the connection between the second physical NIC 102 and the second path management network 500 is disconnected. This configuration eliminates the need for the user to keep track of which of the multiple physical NICs of the computer 100B is to be connected to which path management network.

While the preferred exemplary embodiments of the present invention have been described, it is to be understood that the present invention is not limited to the exemplary embodiments above and that further modifications, replacements, and adjustments may be added without departing from the basic technical concept of the present invention. For example, though the OpenFlow switch or the OpenFlow controller described in Non-Patent Documents 1 and 2 is sometimes used as a component in the exemplary embodiments described above, the present invention is not limited to those devices. Any device having the equivalent function may be used as necessary.

In addition, though an entry for transferring a packet is stored in the routing table in the second and third exemplary embodiments described above, it is of course possible for the path control unit 109/109A to set an entry for discarding a particular packet or to add an entry for rewriting a particular header.

### INDUSTRIAL APPLICABILITY

The present invention is applicable not only to computers in general that must use multiple physical network interfaces according to the packet destinations but also to virtual switches that provide a virtual network for a virtual machine (VM) in the computer. The present invention is applicable also to a virtual switch placed between a virtual NIC, provided by the OS as a program, and a physical NIC.

Finally, as supplementary notes, the following describes the inventions that can be included in the claims of the present invention.

[Supplementary Note 1]

A computer that comprises, instead of the communication analysis unit in the first exemplary embodiment described above, a path control unit that, receiving a packet from the virtual network interface device and using network topology information representing a connection mode of a plurality of managed communication devices, selects to which of the first virtual switch and the second virtual switch the virtual network interface device is to be connected.

[Supplementary Note 2]

A computer wherein the path control unit sets an entry in the routing table of the first virtual switch or second virtual switch to cause the first virtual switch or second virtual switch to perform an action according to a packet.

[Supplementary Note 3]

A computer wherein the path control unit uses the network topology information to determine a transfer path of a packet from the virtual network interface device to the transmission destination computer and selects the first virtual switch or second virtual switch to be connected to the virtual network interface device according to the transfer path.

The disclosure of Non-Patent Documents 1 and 2 given above is hereby incorporated by reference into this specification. The exemplary embodiments and the examples may be changed and adjusted in the scope of the entire disclosure (including claims) of the present invention and based on the basic technological concept. In the scope of the claims of the present invention, various disclosed elements may be combined and selected in a variety of ways. That is, it is apparent that the present invention includes various modifications and changes that may be made by those skilled in the art according to the entire disclosure, including claims, and technological concepts.

What is claimed is:

1. A computer comprising:
a virtual network interface device;
a first virtual switch connected to a first physical network interface device;
a second virtual switch connected to a second physical network interface device;
a communication analysis unit that, based on a result of communication with a packet transmission destination obtained by analyzing a packet transmitted from the virtual network interface device, selects to which of the first virtual switch and the second virtual switch the virtual network interface device is to be connected; and
a connection setting unit that holds a connection between the virtual switch selected by the communication analysis unit and the virtual network interface device.

2. The computer as defined by claim 1, wherein
the first physical network interface device is connected to a first network;
the second physical network interface device is connected to a second network; and,
the connection setting unit disconnects the connection between the virtual network interface device and the virtual switch, when the connection between the first physical network interface device and the first network or the connection between the second physical network interface device and the second network is disconnected.

3. The computer as defined by claim 1 without the communication analysis unit, wherein,
the connection setting unit receives from a path control unit an instruction indicating a virtual switch to be connected to the virtual network interface device;
the connection setting unit holds a connection between the virtual switch indicated by the path control unit and the virtual network interface device; and
the path control unit, receiving a packet from the virtual network interface device and using network topology information representing a connection mode of a plurality communication devices managed by the path control unit, selects to which of the first virtual switch and the second virtual switch the virtual network interface device is to be connected.

4. The computer as defined by claim 3, wherein
the first and second physical network interface devices are connected respectively to first and second physical switches controlled by the path control unit.

5. The computer as defined by claim 3, wherein
the path control unit, using the network topology information, as well as failure information or traffic information collected from at least one of the plurality of the communication devices, selects to which of the first virtual switch and the second virtual switch the virtual network interface device is to be connected.

6. The computer as defined by claim 3, wherein
the path control unit sets an entry in a routing table of each communication device on the first network or the second network to control a path of a packet transmitted and received between the virtual network interface device and a transmission destination computer.

7. A network connection switching method comprising:
based on a result of communication with a packet transmission destination obtained by analyzing a packet transmitted from the virtual network interface device included in a computer, selecting to which of a first virtual switch and a second virtual switch a virtual network interface device is to be connected; and
connecting the selected virtual switch and the virtual network interface device.

8. A communication system comprising a computer and a path control unit, wherein
the computer comprises: a virtual network interface device;
a first virtual switch connected to a first physical network interface device;
a second virtual switch connected to a second physical network interface device; and
a connection setting unit that receives from the path control unit an instruction indicating a virtual switch to be connected to the virtual network interface device and holds a connection between the virtual switch and the virtual network interface device, and
the path control unit, receiving a packet from the virtual network interface device and using network topology information representing a connection mode of a plurality of communication devices managed by the path control unit, selects to which of the first virtual switch and the second virtual switch the virtual network interface device is to be connected.

9. The communication system as defined by claim 8, wherein
the first and second physical network interface devices are connected respectively to first and second physical switches controlled by the path control unit.

10. The communication system as defined by claim 8, wherein
the path control unit, using the network topology information, as well as failure information or traffic information collected from at least one of the communication devices, selects to which of the first virtual switch and the second virtual switch the virtual network interface device is to be connected.

11. The communication system as defined by claim 8, wherein
the path control unit sets an entry in a routing table of each communication device on the first network or the second network to control a path of a packet transmitted and received between the virtual network interface device and a transmission destination computer.
